(19) United States
(12) Patent Application Publication
(10) Pub. No.: US 2009/0270776 A1
(43) Pub. Date: Oct. 29, 2009

(54) Massage Chair With Function of Stress Relaxation and Sleep Inducing

(76) Inventor: Hung-Chu Chang, Changhua County (TW)

Correspondence Address: Dr. BANGER SHIA, 102 Lindencrest Ct., Sugar Land, TX, 77479-5201, US

(21) Appl. No.: 12/110,772

(22) Filed: Apr. 28, 2008

(51) Int. Cl. A61H 7/00

(52) U.S. Cl. 601/84

(57) ABSTRACT

A massage chair with function of stress relaxation and sleep inducing comprises a chair and a head cove. When sitting in the chair, the user can use the head cover to cover his head and then turn on the light emitting unit and the sound generating unit to send out light and sound that have the frequency as one or combination of the δ, α, θ and β brainwaves toward the user's eyes and ears synchronously. The light and sound wave are used to affect the user's brainwaves, and the music covers the boring sound wave, thus creating a happy and relaxed atmosphere for the user and guiding him into a desired state, such as relaxed yet alert state, shallow sleep state, deep sleep state, by guiding his brainwaves.

### BACKGROUND OF THE INVENTION

1. Field of the Invention

The present invention relates to a physiotherapeutic instrument, and more particularly to a massage chair with function of stress relaxation and sleep inducing.

2. Description of the Prior Art

Message is an action of continuously or intermittently applying force to specific parts of a human's body to relax muscle tension and improve blood circulation, making the user feel relaxed mentally and physically. Especially, appropriate acupuncture point massage is also good for health in many respects.

Hence, many massage devices appear in the market, among them, massage chair is particularly popular because in addition to providing massage function, the massage chair also allows the user to sit comfortably, thus the massage effect would be enhanced. Moreover, the inventor of this application discloses a “head cover device for a massage chair” in his earlier invention, TW Pat. No. 095208321, wherein an adjustable head cover is disposed at the headrest portion of the massage chair to create a quiet space isolated from outside light and noise, allowing the user to enjoy the massage comfortably. Further, in the head cover are additionally provided lamps for generating α ray to modify the user's magnetic field and improve physical function.

Although the massage chair can make the user relaxed physically and is also provided with an α ray lamp which can improve the user's physical function, its function and effect on mental relaxation is still very limited. Nowadays, many people are afflicted by mental health problems which are caused by the factors, such as stress, worriment, uneasiness, and even worse, these factors may lead to insomnia. No matter how good the massage effect of the massage chair is, it cannot relax the user mentally.

Researches have shown that human brain produces four types of brainwaves: δ (below 4 Hz) θ (4-8 Hz) α (8-13 Hz) and β (above 13 Hz). β brainwaves are present when a person is in an alert state while carrying out focused activities, like thinking. α brainwaves are present when the person is relaxed yet still alert. θ brainwaves appear when the person is sleepy and experiencing dreams, and δ brainwaves are found in a deep and dreamless sleep state.

For signals with the same frequency as one of the α, β, θ and δ brainwaves, such as sound and light, they are transmitted in this way: the sound wave is first transmitted from eardrum to middle ear, and then to the malleus, incus and stapes, and after that the lymph of the cochlea stimulates the hearing organs to instruct the auditory nerve to convert the frequency of the sound waves into signal and transmit it to the pallium. The light is received by eyes first and converted into signal by optic nerve and then transmitted to the pallium. It is apparent that light or sound wave with a certain frequency can affect the brainwaves.

Hence, guiding the brainwaves can switch brain into alert or sleep state, or can even help the brain think or relax, and the present invention is aimed at finding a solution to combine such a technology with the massage.

### SUMMARY OF THE INVENTION

The primary objective of the present invention is to provide a massage chair with function of stress relaxation and sleep inducing. In the head cover of the massage chair are provided a light emitting unit and a sound generating unit. The sound generating unit is used to play out sound waves which have the same frequency as the α, β, θ and δ brainwaves, and the light emitting unit serves to produce light which has the same frequency as the α, β, θ and δ brainwaves. The sound and light affect the user's brainwaves synchronously, so as to guide the user into a desired state. To achieve this objective, the massage chair is provided with a chair and a head cover pivoted to the top end of the chair. The sound generating unit is disposed in the head cover, and in the inner surface of the head cover is further arranged a plurality of light emitting units. The sound generating unit is disposed on an inner surface of the head cover.

When sitting in the chair, the user can use the head cover to cover his head and then turn on the light emitting unit and the sound generating unit to send out music, sound wave and light, synchronously. The light and sound waves are used to affect the user's brainwaves, and the music covers the boring sound wave, thus creating a happy and relaxed atmosphere for the user and guiding him into a desired state.

### BRIEF DESCRIPTION OF THE DRAWINGS

FIG. 1 is a perspective view of a massage chair with function of stress relaxation and sleep inducing in accordance with the present invention;

FIG. 2 is an illustrative diagram showing the connection of the light emitting unit, sound generating unit, and the memory access unit in accordance with the present invention;

FIG. 3 shows a state that the user is being massaged by the massage chair in accordance with the present invention;

FIG. 4 shows that the sound generating unit is disposed on the chair back of the massage chair in accordance with the present invention; and

FIG. 5 shows that the sound generating units are disposed both in the head cover and on both top sides of the chair back of the chair.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

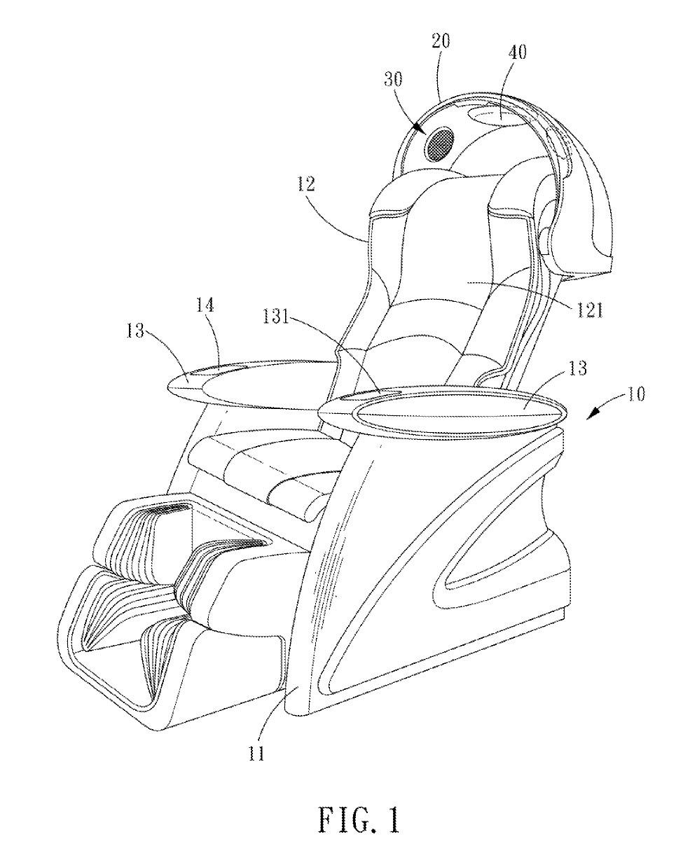

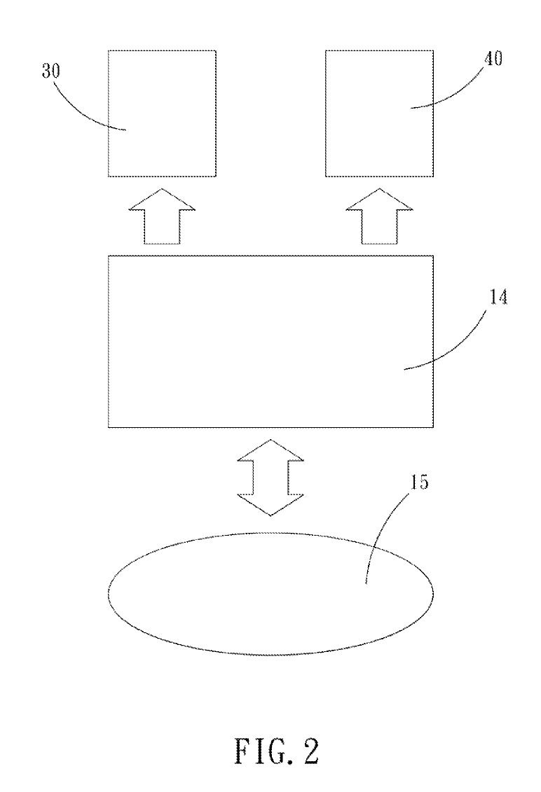

Referring to FIGS. 1 and 2, a massage chair with function of stress relaxation and sleep inducing in accordance with the present invention comprises: a chair 10 on which are provided a head cover 20, two sound generating units 30 and a light emitting unit 40.

The chair 10 allows the user to sit and includes a base 11, a chair back 12 and two armrests 13. One end of the base 11 is pivotally coupled to the lower end of the chair back 12, and inside the chair back 12 are provided with massage devices (not shown). The chair back 12 includes a support surface 121 for the user to lean against. The armrests 13 are disposed at both sides of the base 11 and each is provided on its surface with a control 14 for controlling the massage operation of the chair back 12. Each control 14 is equipped with a memory access unit 15 which has data storing and reading function and cooperates with the control 14 to control the programmed operation of the massage chair. The memory access unit 15 is stored with types of sound control signals, light control signals, massage operation control signals and music waves, which have the same frequency as one of the α, β, θ and δ brainwaves.

The head cover 20 is pivotally disposed on the top end of the chair back 12 of the chair 10 and is pivotable toward the support surface 121 of the chair back 12 to cover the user's head.

The sound generating units 30 are disposed in the head cover 20 and located at both inner sides of the head cover 20 to produce sound under the control of the controls 14. The sound control signals are first read by the controls 14 from the memory access unit 15, and then the sound generating units 30 play out sound or music.

The light emitting unit 40 is disposed in the head cover 20 and controlled by the controls 14. The controls 14 can read the light control signals in the memory access unit 15 and then instruct the light emitting unit 30 to selectively produce a type of light which has the same frequency as one of the δ, α, θ and β brainwaves. After the user's head is covered by the head cover 20, the light emitted from the light emitting unit 40 is directed toward the support surface 121 of the chair back 12, right in the direction of the use's face.

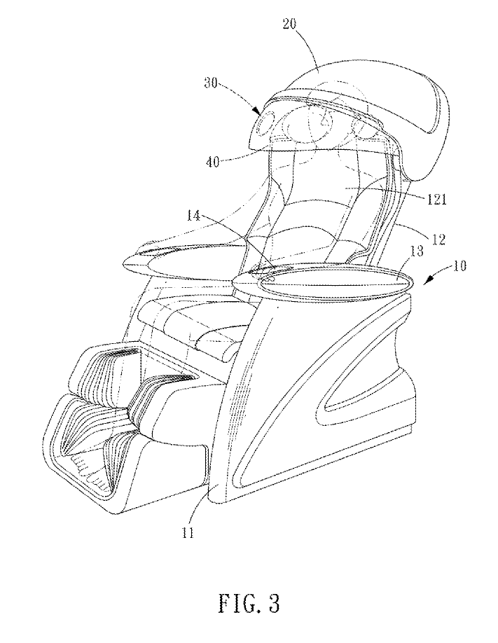

For a better understanding of the present invention, its operation and function, reference should be made to FIGS. 2 and 3. When a user sits in the base 11 of the chair 10 with his back leaning against the support surface 121 of the chair back 12, the controls 14 can be used to read the massage control signals in the memory access unit 15 and instruct the massage devices of the chair back 12 to perform massage operation according to predetermined programs. When the head cover 20 covers the user's head, the sound generating units 30 will be at both sides of the user's ears, and the light emitting units 40 will be in front of the user's head and directed toward his eyes. At this moment, the user can control the operation of the sound generating units 30 and the light generating unit 40 through the controls 14 on the armrests 13.

To operate the sound generating units 30, the user can use the controls 14 to read sound wave control signals from the memory access unit 15 and instruct the sound generating units 30 to play out music or sound that have the same frequency as one of the δ, α, θ and β brainwaves. After entering the user's ears, the sound waves will be converted into signals and transmitted to brain, so as to affect the user's brainwaves.

To operate the light emitting unit 40, the user can use the controls 14 to read light control signals from the memory access unit 15 and instruct the light emitting unit 14 to send out light that has the same frequency as one of the δ, α, θ and β brainwaves. The light is converted into signal by the optic nerve and then transmitted to brain to affect the user's brainwaves. It is to be noted that light and sound wave have the same frequency, the present invention can also be controlled to produce two, three or four types of light and sound wave synchronously which have the same frequency as the δ, α, θ and β brainwaves.

It is to be noted that the sound wave which has the same frequency as one of the δ, α, θ and β brainwaves is a very monotonous sound, it sounds like: da, da . . . . Hence, the sound emitting unit plays a dulcet music to cover the monotonous sound. Further, the memory access unit 15 also allows the user to input his favorite music, creating a happy and relaxed atmosphere.

In addition, with the controls 14, the user can selectively control the sound generating units 30, the light emitting unit 40 and the massage devices to operate together or separately.

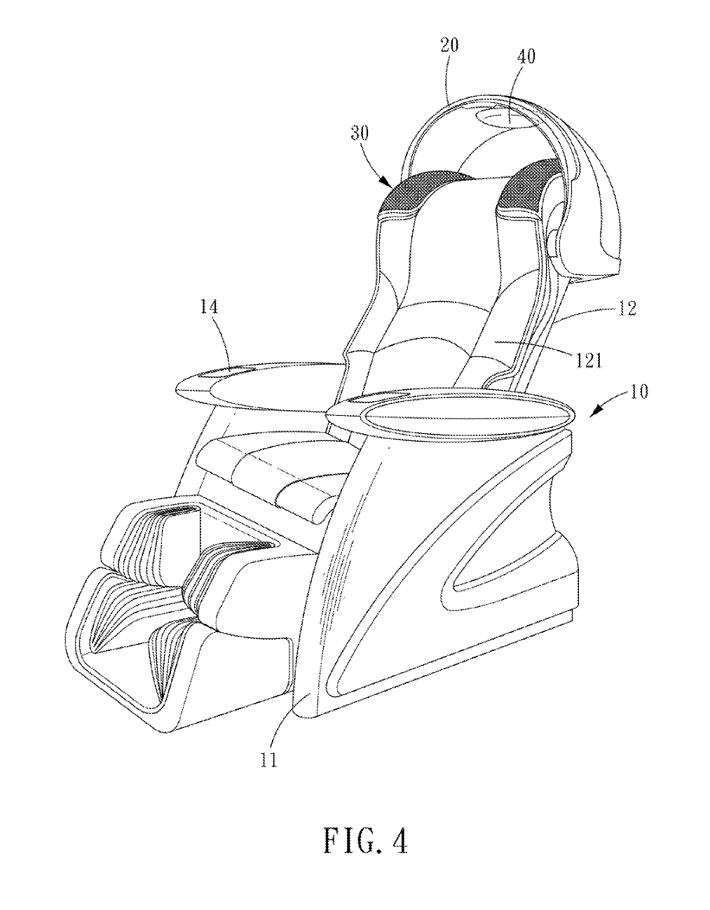

Referring to FIG. 4, the sound generating units 30 can be disposed on both top sides of the chair back 12 of the chair 10, when a user sits in the base 11 of the chair 10 with his back leaning against the support surface 121 of the chair back 12, the sound generating units 30 will right be at both sides of the user's ears.

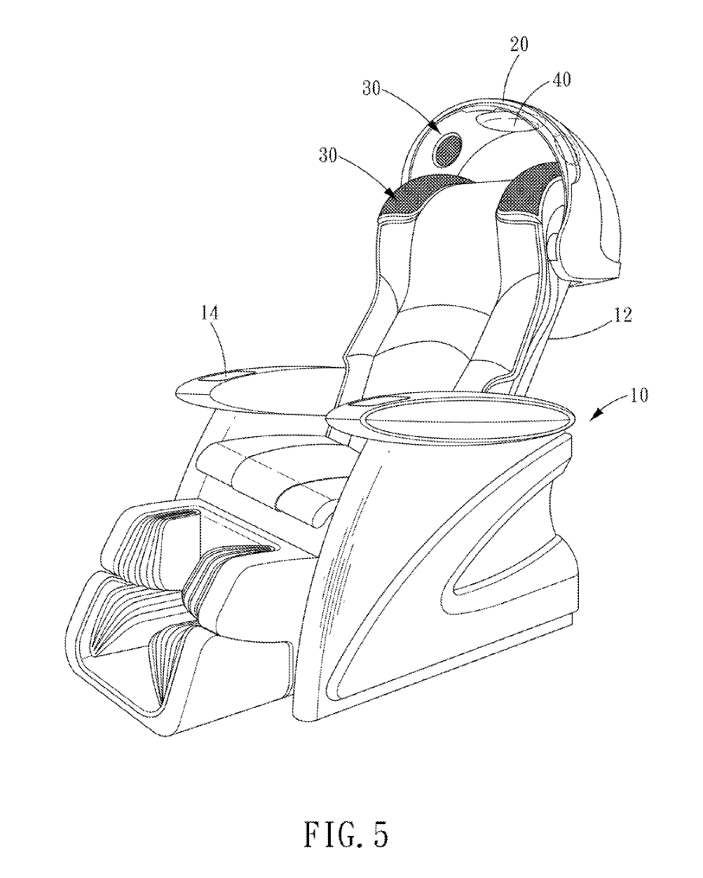

In addition, the sound generating units 30 can also be disposed both in the head cover 20 and on both top sides of the chair back 12 of the chair 10, as shown in FIG. 5.

It is to be noted that the memory access unit 15 can be in form of a quickly replaceable storage medium, such as SD memory card, optical disc, magnetic disc, hard disc, flash memory, and etc. The operation modes, including the sound waves, music, are pre-stored in the memory access unit, so that the user can choose different operation modes to meet different needs. For example, operation mode A is for maniac-depressive disorder patient, and operation mode B is for pure relaxation.

While we have shown and described various embodiments in accordance with the present invention, it is clear to those skilled in the art that further embodiments may be made without departing from the scope of the present invention.

What is claimed is:

1. A massage chair with function of stress relaxation and sleep inducing comprising:
a chair including a base, a chair back and a control, one end of the base being coupled to a lower end of the chair back, the chair back having a support surface for a user to lean against, the control being equipped with a memory access unit for cooperating with the control to control operation of the massage chair, the memory access unit being stored with sound control signals, light control signals, massage operation control signals and music waves, which have the same frequency as one of α, β, θ and δ brainwaves;
a head cover pivotally being disposed on a top end of the chair back of the chair and pivotable toward the support surface of the chair back to cover the user's head;
a sound generating unit disposed in the head cover and controlled by the control to produce sound waves and music which have the same frequency as the α, β,θ 0 and δ brainwaves; and
a light emitting unit disposed in the head cover and controlled by the controls to produce light which has the same frequency as the α, β, θ and δ brainwaves.

2. The massage chair with function of stress relaxation and sleep inducing as claimed in claim 1, wherein the sound generating unit is disposed on an inner surface of the head cover.

3. The massage chair with function of stress relaxation and sleep inducing as claimed in claim 1, wherein the sound generating unit is disposed at both top sides of the chair back and play out sound toward the head cover.

4. The massage chair with function of stress relaxation and sleep inducing as claimed in claim 1, wherein the sound waves emitted from the sound generating unit have the same frequency as the light emitted from the light emitting unit.

5. The massage chair with function of stress relaxation and sleep inducing as claimed in claim 1, wherein the base is provided with two armrests at both sides thereof, and the control is disposed on the armrests for controlling the sound generating unit and the light emitting unit.
